(19) United States
(12) Patent Application Publication
(10) Pub. No.: US 2018/0339575 A1
(43) Pub. Date: Nov. 29, 2018

(54) VEHICLE VISOR DEVICE AND SYSTEM

(71) Applicant: DANIEL JOHANANOFF, Sloatsburg, NY (US)

(72) Inventor: DANIEL JOHANANOFF, Sloatsburg, NY (US)

(21) Appl. No.: 15/992,152

(22) Filed: May 29, 2018

Related U.S. Application Data
(60) Provisional application No. 62/511,618, filed on May 26, 2017.
(60) Provisional application No. 62/564,192, filed on Sep. 27, 2017.

(51) Int. Cl. B60J 3/02

(52) U.S. Cl. CPC B60J 3/0208; B60J 3/0226

(57) ABSTRACT

Disclosed herein are visor devices and systems for providing shade in a vehicle including: a base plate or bracket configured to be releasably secured to a portion of a vehicle; an auxiliary visor panel rotatably connected to the base plate or bracket; and a glare shield movably connected to the auxiliary visor panel. Also disclosed herein are method of using the disclosed devices and systems.

### CROSS REFERENCE TO RELATED APPLICATIONS

The application claims the benefit of priority to U.S. Provisional Patent Application Ser. No. 62/511,618, filed May 26, 2017, and U.S. Provisional Patent Application Ser. No. 62/564,192, filed Sep. 27, 2017, which are hereby incorporated herein by reference in their entirety.

### FIELD OF INVENTION

The present invention relates to vehicle visor devices and systems for shading.

### BACKGROUND OF THE INVENTION

While driving, it is often necessary or desirable to shade oneself from excessive and potentially dangerous sun or bright glare. Vehicle visors are a common type of device that are used to provide protection from sun or bright light in certain settings. For example, the vehicle visor can be pivoted down to offer protection from exposure directly ahead or can be positioned against the side window to shade sun or bright light coming through the side window. However, standard vehicle visors only offer protection from sun or shade coming from a single direction, and are difficult to move and position with the changing sun.

Accordingly, there remains a need for new vehicle shading devices and systems which are capable of easily being moved in a number of positions and should preferably be able to be secured to an existing vehicle structure. This need and other needs are satisfied by the various aspects of the present disclosure.

### SUMMARY OF THE INVENTION

In accordance with the purposes of the invention, as embodied and broadly described herein, the invention, in one aspect, relates to a visor device and system for providing shade or glare reduction comprising: a base plate or bracket configured to be releasably secured to a portion of a vehicle; an auxiliary visor panel pivotably connected to the base plate; and a glare shield movably connected to the auxiliary visor panel.

In another exemplary aspect, the invention relates to a visor system, the system comprising: at least one base bracket configured to be releasably secured to a portion of a vehicle, the base bracket comprising a plurality of securing means configured to be secured to a plurality of portions of the vehicle visor; at least one auxiliary visor panel pivotably connected to the base bracket using a pivot ball joint; wherein the pivot ball joint comprises a pivot ball with a pin extending therefrom, a socket for receiving said ball, and a retaining means for securing the pivot ball in the socket; and a glare shield movably connected to the auxiliary visor panel.

In further aspects, the invention also relates to methods for using the disclosed devices and systems.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 shows a depiction of a visor system in accordance with an exemplary embodiment of the present invention.

FIG. 2 shows a depiction of a visor system in accordance with an exemplary embodiment of the present invention.

FIG. 3 shows a depiction of a base plate of a visor system in accordance with an exemplary embodiment of the present invention.

FIG. 4 shows a depiction of a base plate of a visor system in accordance with an exemplary embodiment of the present invention.

FIG. 5 shows a depiction of a base plate of the visor system in accordance with an exemplary embodiment of the present invention.

FIG. 6 shows a depiction of a visor system in accordance with an exemplary embodiment of the present invention.

FIG. 7 shows a depiction of a visor system secured to an OEM vehicle visor in accordance with an exemplary embodiment of the present invention.

FIG. 8 shows a depiction of a visor system in accordance with an exemplary embodiment of the present invention.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an aperture” includes two or more apertures.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices and articles of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Visor Devices and Systems

As briefly described above, the present disclosure relates, in various aspects, to visor devices and systems for providing shade, such as from the sun, or the like. In one aspect, the present disclosure provides a visor system comprising: a base plate configured to be releasably secured to a portion of a vehicle; an auxiliary visor panel rotatably or pivotably connected to the base plate; and a glare shield movably connected to the auxiliary visor panel. In another aspect, the present disclosure provides visor systems comprising: at least one base bracket configured to be releasably secured to a portion of a vehicle; at least one auxiliary visor panel rotatably or pivotably connected to the base bracket; and a glare shield movably connected to the auxiliary visor panel.

In further aspects, the system may comprise a plurality of base plates or brackets. In still further aspects, the system may comprise a plurality of auxiliary visor panels. In some aspects, the base plate may be substantially planar. In other aspects, the base plate may comprise a void in the central portion. In further aspects, the base plate may comprise or otherwise take the form of a bracket. In still further aspects, the base plate may comprise a socket for receiving a pivot ball. In even further aspects, the base plate may comprise a pivot ball joint. In yet further aspects, the void in the central portion can comprise a socket for receiving a pivot ball configured to rotate about in the socket.

In further aspects, the base plate is releasably secured using a securing means. In still further aspects, the base plate can be releasably secured to a vehicle visor or roof. In yet further aspects, the base plate or bracket may comprise a plurality of securing means. In some aspects, the base plate or bracket comprises a rectangular shape. In other aspects, the base plate or bracket comprises a triangular shape, and is configured to be secured to a corner of the vehicle visor.

In further aspects, the base plate may comprise at least one aperture for receiving the securing means. In still further aspects, the base bracket may comprise a plurality of apertures for receiving the securing means. In yet further aspects, the base plate may comprise at least two apertures for receiving a securing means, the apertures being contained within a base plate edge. In even further aspects, a first end of the securing means may be detachably connected to the base plate by extending through a first aperture from a first side of the base plate to a second side of the base plate, and by extending through a second aperture from the second side of the base plate to the first side of the base plate.

In further aspects, the base plate may comprise a first side and a second side. In still further aspects, the first side of the base plate may be configured to be secured against a surface, such as, and without limitation, against an original equipment manufacturer (OEM) visor. In yet further aspects, the first side of the base plate may further comprise a gripping portion, such as, for example, to enhance grip against the surface to which it is secured. In even further aspects, the second side of the base plate may comprise a pivot ball joint. In some aspects, the first side of the base plate may comprise a gripping portion, such as, for example, to enhance grip against the surface to which it is secured, and the second side of the base plate may comprise a pivot ball joint.

In further aspects, the device and system may further comprise an extendable member, the extendable member having first and second opposed ends. In still further aspects, the extendable member may be connected to the auxiliary panel at a first end. In yet further aspects, the extendable member may comprise an extension rod. In even further aspects, the extendable member may be connected to the auxiliary panel at a first end and may comprise an extension rod at a second end. In still further aspects, the extendable member may comprise a flexible portion at a first end and a rigid portion at a second end. In yet further aspects, the extension rod may be configured to telescope from within the extendable member or an extendable member housing. In even further aspects, at least a portion of the extendable member may be configured to be releasably secured to an OEM visor retention device or clip.

In further aspects, the auxiliary panel comprises at least one of: at least one internal housing and at least one outer casing. In still further aspects, the auxiliary panel comprises at least one internal housing and at least one outer casing. In yet further aspects, the internal housing may comprise a first internal housing panel and a second internal housing panel.

In further aspects, the auxiliary visor panel can be pivotably connected using a connecting means. In even further aspects, the auxiliary visor panel can be pivotably connected using a pivot ball joint, or the like. In various aspects, the auxiliary visor panel can work with existing vehicle visor to extend the range of shading or blocking of sun. For example, in some aspects, the auxiliary visor panel can be pivotally mounted to a vehicle visor such that it can pivot downwardly and away from the primary visor without encroaching in the user's space when the vehicle visor is in the side window position.

In further aspects, the pivot ball joint can comprise a pivot ball with a pin extending therefrom, a socket for receiving said ball, and a cover plate for securing the pivot ball in the socket. In even further aspects, the pivot ball can provide motion to the auxiliary visor. In still further aspects, the cover plate comprises guide slots configured to receive the pin and control the motion of the auxiliary visor panel. In

In various aspects, the cover plate can be configured to allow the auxiliary visor panel to move to a predetermined position. In further aspects, the pivot ball joint can also comprise a retaining means configured to hold the auxiliary visor panel in a predetermined position, for example, by adding friction at the pivot ball connection. In still further aspects, the retaining means can comprise a friction fitting, snap ring, O-ring, pressure fitting, clip, clasp, and the like. In even further aspects, the snap ring or O-ring can be retained within a groove to accommodate the snap ring or O-ring.

In father aspects, the retaining means may comprise an adjustment knob or member. In still further aspects, the adjustment knob or member may include at least one of a clamping arm and clamping face. In yet further aspects, the adjustment knob or member may be configured to control the motion of the auxiliary visor panel by adjusting the adjustment knob or member towards and away from the pivot ball. In even further aspects, the adjustment knob or member may be configured to prevent motion of the auxiliary visor panel by screwing the adjustment knob or member towards the pivot ball. In still further aspects, the adjustment knob or member may be configured to allow motion of the auxiliary visor panel by screwing the adjustment knob or member away from the pivot ball. In yet further aspects, the adjustment knob or member may be configured to control the motion of the auxiliary visor panel by tightening a clamping face of the adjustment knob or member against the pivot ball. In even further aspects, the adjustment knob or member may be configured to prevent movement of the auxiliary visor panel by tightening a clamping face of the adjustment knob or member against the pivot ball. In still further aspects, the adjustment knob or member may be configured to fix the auxiliary visor panel position by tightening a clamping face of the adjustment knob or member against the pivot ball. In some aspects, a clamping face of the adjustment knob or member may have an arcuate shape substantially matching the shape of the pivot ball. In other aspects, a clamping face of the adjustment knob or member may have an arcuate shape identically matching the shape of the outer portion of pivot ball.

In further aspects, the cover plate can be configured to allow the auxiliary visor panel to move to a plurality of predetermined positions. In still further aspects, the cover plate can be configured to allow the auxiliary visor panel to move from a first predetermined position to a second predetermined position or a third predetermined position, or any combination thereof. In yet further aspects, the predetermined position can comprise a stowed position against the vehicle visor, a side window position, or an extended position against the windshield, or any combination thereof.

In further aspects, the auxiliary visor panel can comprise a cavity or void for receiving the glare shield. In some aspects, the glare shield can be slidably connected to the auxiliary visor panel. In other aspects, the glare shield can be pivotably connected to the auxiliary visor panel. In still further aspects, the glare shield can be connected using a connecting means. In yet further aspects, the glare shield can be configured to extend from the auxiliary visor panel to reduce glare or bright light when the auxiliary visor panel is a raised position. In yet further aspects, the system can comprise a button or other release mechanism configured to release a component, such as, for example, the glare shield from a secured position.

In various aspects, the base plate may comprise at least one securing means configured to be secured to first portion of a vehicle visor; and the auxiliary panel may also comprise at least one securing means configured to be secured to a second portion of a vehicle visor. In further aspects, the at least one securing means of the auxiliary panel comprises a magnet and corresponding magnetic element, the magnet being configured to magnetically couple with the corresponding magnetic element. In still further aspects, at least a portion of the auxiliary securing means may be disposed within the auxiliary panel. In yet further aspects, the magnet may be disposed within the auxiliary panel. In even further aspects, the magnet may be disposed within the internal housing of the auxiliary panel. In still further aspects, the magnet may be disposed within the internal housing of the auxiliary panel and the corresponding magnetic element is disposed on a surface of or within a vehicle visor, such as an OEM visor. In various further aspects, the magnetic element may comprise a metal plate, or other magnetic plate.

In further aspects, the base plate can comprise a plurality of securing or connecting means, such as, and without limitation, VELCRO at one portion and a clamping mechanism on another portion of the base plate. In still further aspects, the base plate can comprise a securing means for releasably securing the auxiliary visor panel to the base plate. In yet further aspects, the base plate can have a rectangular, arcuate, v-shaped, oval, round, or cylindrical shape.

In further aspects, the glare shield can be comprised of an UV-reducing and/or glare-reducing material, or a combination thereof. In still further aspects, the glare shield can be comprised of an opaque, micro-louver, transparent, tinted, translucent, polarized, phototropic, electrochromic, fabric, cloth, plastic, woven or non-woven, natural or synthetic material, or combinations thereof. In some aspects, the glare shield can comprise a tinted acrylic panel.

In further aspects, disclosed herein are visor systems comprising: at least one base bracket configured to be releasably secured to a portion of a vehicle, the base bracket comprising a plurality of securing means configured to be secured to a plurality of portions of the vehicle visor; at least one auxiliary visor panel pivotably connected to the base bracket using a pivot ball joint; wherein the pivot ball joint comprises a pivot ball with a pin extending therefrom, a magnetic socket for receiving said ball, and a retaining means for securing the pivot ball in the socket; and a glare shield movably connected to the auxiliary visor panel.

In further aspects, the disclosed visor systems, and portions thereof, may be installed as OEM equipment in vehicles. For example, in some aspects, the base plate or base bracket may be present as an OEM vehicle part, and the auxiliary visor panel may be configured to be attached to the OEM part by inserting the pivot ball in the socket. In still further aspects, the visor system can comprise at least one auxiliary visor panel configured to be pivotably connected to a portion of a vehicle roof or visor using a pivot ball joint; wherein the pivot ball joint comprises a pivot ball with a pin extending therefrom, a socket or magnetic socket for receiving said ball, and a retaining means for securing the pivot ball in the socket; and a glare shield movably connected to the auxiliary visor panel. In other aspects, the base plate may be an OEM vehicle visor comprising a socket for receiving the pivot ball, and the auxiliary visor panel sold separately, such as a dealer installed option, and is configured to be attached by inserting the pivot ball in the OEM installed socket.

In still further aspects, the base bracket can comprise a triangular shape, and be configured to be secured to a corner of the vehicle visor. In yet further aspects, at least one securing means is configured to be secured to first portion of the vehicle visor, and at least one other securing means is configured to be secured to a second portion of the vehicle visor. In even further aspects, the auxiliary visor panel further comprises a securing means configured to releasably secure a portion of the auxiliary visor panel to third portion of the vehicle visor.

In various aspects, the securing means comprises a clip, clamp, latch, bracket, snap, fitting, clasp, Velcro, strap, tie wraps, hook and latch, loop and tie, cable, elastic, band, button and buttonholes, or combinations thereof. In further aspects, the connecting means comprises a hinge or similar connecting mechanism. In further aspects, the components can be releasably connected. In a still further aspect, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the system can comprise an engagement means for coupling and holding components together. In a further aspect, the engagement means can be a screwing mechanism, a click-lock mechanism, or friction mechanism, or the like. In other aspects, the connecting means can comprise a fitting, insert, adhesive, brazing, soldering, welding, spot weld, screw with nut, or rivet, or a combination thereof.

In further aspects, the system may comprise first and second auxiliary visor panels that flushly nest with the other components when in a closed position. In still further aspects, the base plate can be rotatably connected to a first edge of the first auxiliary visor panel, and the second auxiliary visor panel is rotatably connected to a different edge of the first auxiliary visor panel. The second auxiliary visor panel may be nestably connected to the first auxiliary visor panel, and the second auxiliary visor panel comprises a first edge configured to releasably couple with a first auxiliary visor panel edge and a second edge configured to releasably couple with a base plate edge. In even further aspects, a first auxiliary visor panel may comprise three edges that define a portion of a cavity for receiving a portion of the second auxiliary visor panel. In even further aspects, one surface of the base plate may comprise an elevation portion and a recessed portion, the recessed portion being configured to nestably receive at least a portion of the first auxiliary visor panel, and the elevated portion of the base plate and the cavity of the first auxiliary visor panel forming a substantially planar surface when in the nesting position. In further aspects, the system may comprise a support clip configured to releasably secure a portion of the auxiliary visor panel adjacent to a portion of the vehicle visor, and a glare shield movably connected to the auxiliary visor panel.

Without wishing to be bound by a particular theory, the combination of inventive arm connecting configurations, and/or securement devices allow the visor system to be used in numerous lighting and sun conditions. In further aspects, the present system eliminates the need to uninstall your existing vehicle visor and/or replace the hinges and mounts before installing a double visor which won't fit most vehicles as well as the original visor. With the present system, a user can secure the base plate to the original visor and have multiple shading options.

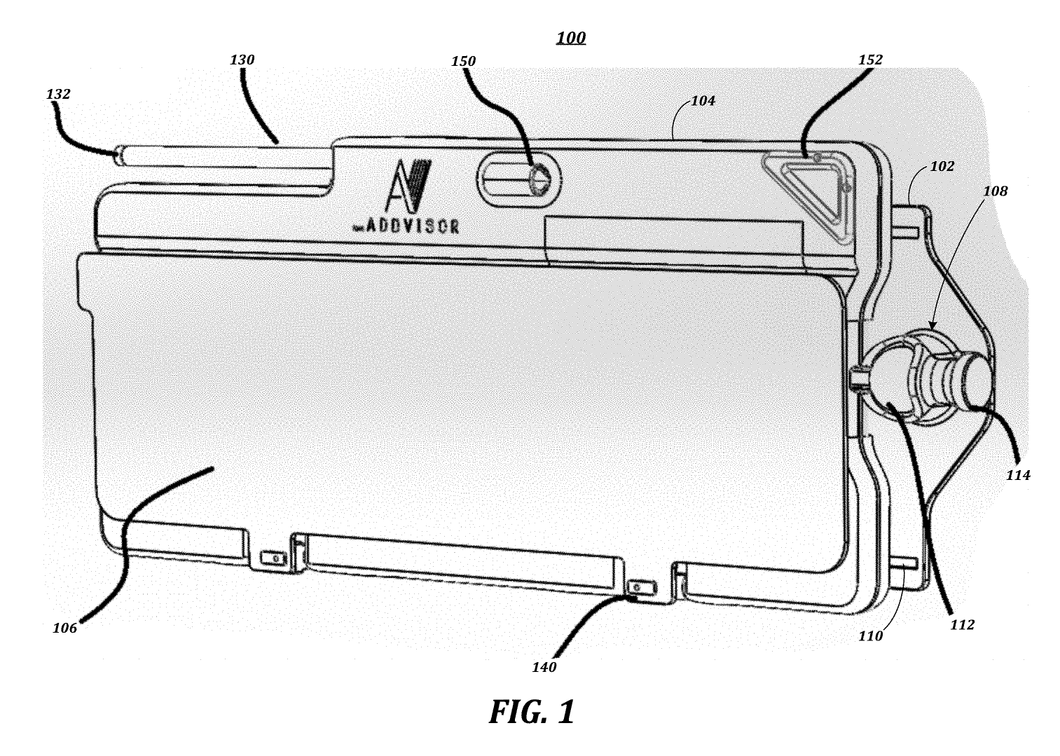

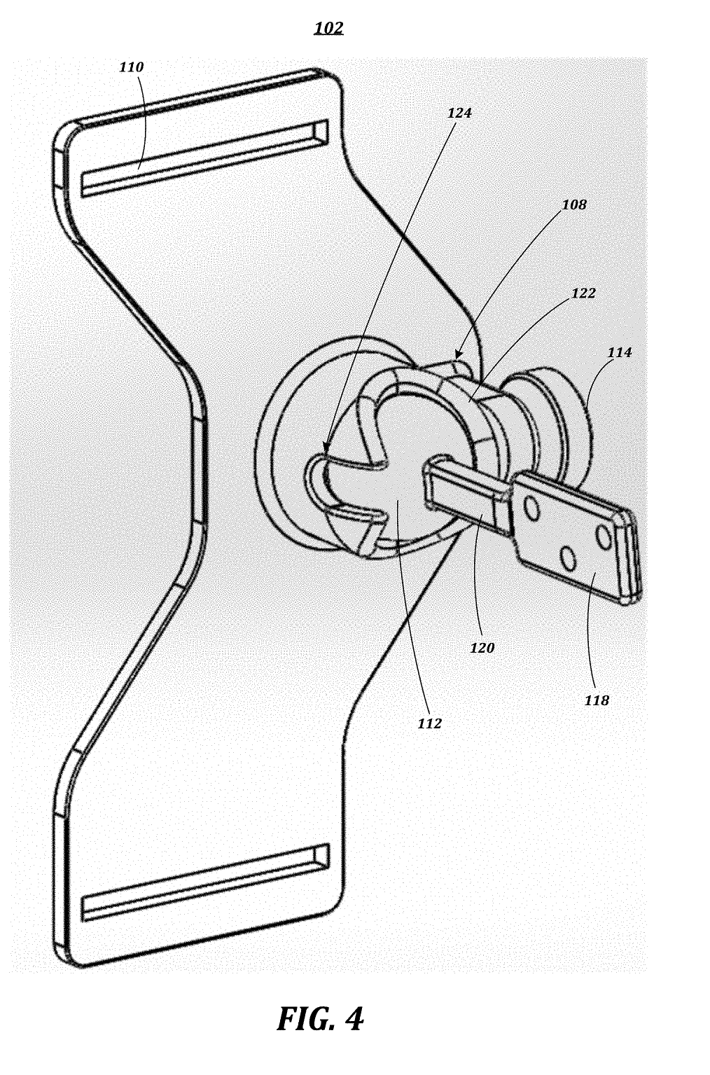

According to various aspects of the invention, the shading devices and systems can comprise multiple configurations. Various exemplary embodiments of the inventive visor devices and systems and methods for using same are shown in FIGS. 1-8.

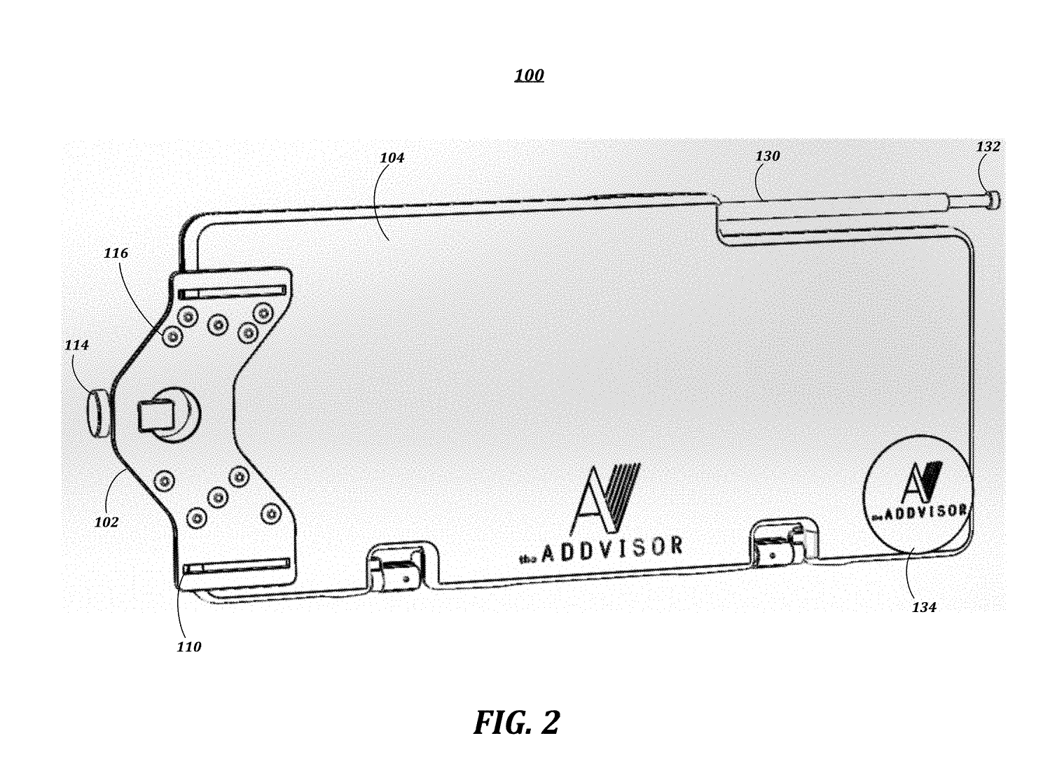

In further aspects, FIGS. 1-2 show various views and perspectives of an exemplary visor system 100 in accordance with the present invention. As shown in FIG. 1, the visor system 100 comprises a base plate 102 configured to be releasably secured to a portion of a vehicle visor; an auxiliary visor panel 104 pivotably connected to the base plate 102; and a glare shield 106 movably connected using hinges 140 to the auxiliary visor panel 104. The base plate comprises a pivot ball joint 108, and the auxiliary visor panel 104 is pivotably connected using the pivot ball joint 108. As shown on a first side, the pivot ball joint 108 of the base plate 102 comprises two apertures 110 for receiving a securing means, the apertures being contained within a base plate edge. In even further aspects, a first end of the securing means (not shown) such as a strap, may be detachably connected to the base plate by extending through a first aperture from a first side of the base plate to a second side of the base plate, and by extending through a second aperture from the second side of the base plate to the first side of the base plate. The pivot ball joint 108 further comprises a pivot ball 112 connected to the auxiliary panel and an adjustment knob 114 configured to fix the position or otherwise control the motion of the auxiliary visor panel by adjusting the adjustment knob, for example, by screwing the adjustment knob towards the pivot ball. The auxiliary panel may further comprise extendable member 130 is connected to the auxiliary panel at a first end and comprising an extension rod 132 at a second end. The auxiliary panel may optional comprise a writing instrument holder 150 and card holder 152. FIG. 2 shows a second side of the visor system 100. As shown in FIG. 2, a second side of the base plate may be configured to be secured against a surface of the vehicle, such as, for example an OEM car visor. In further aspects, the base plate may comprise gripping portions 116 to enhance grip against the surface to which it has been secured.

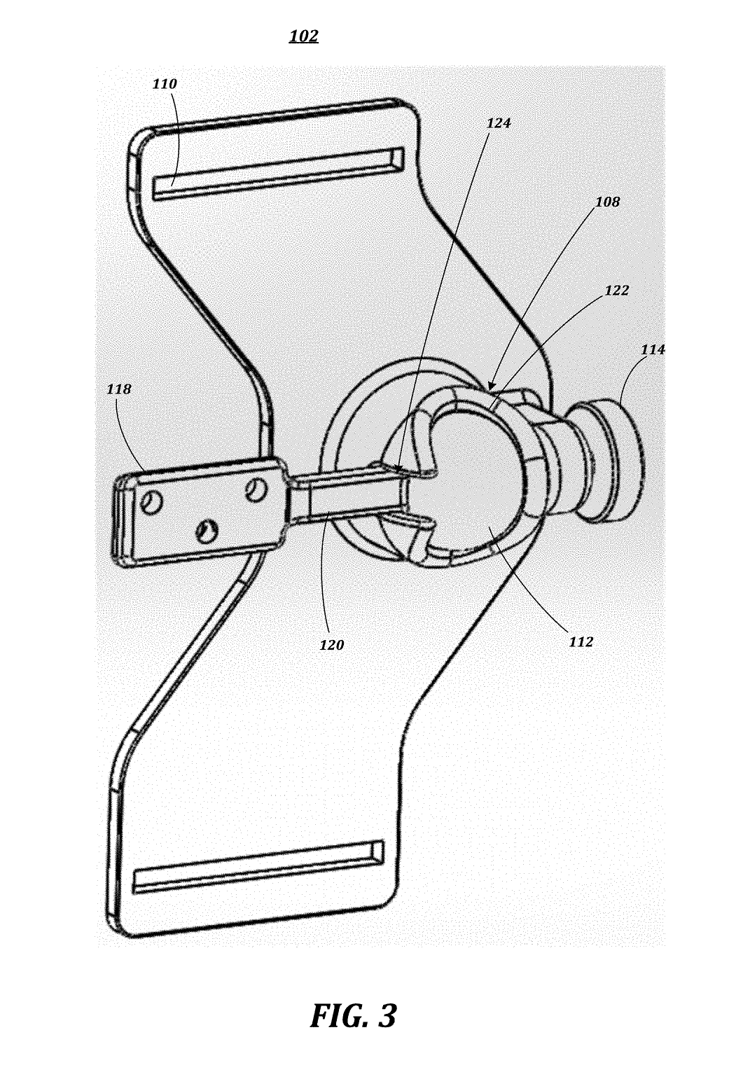

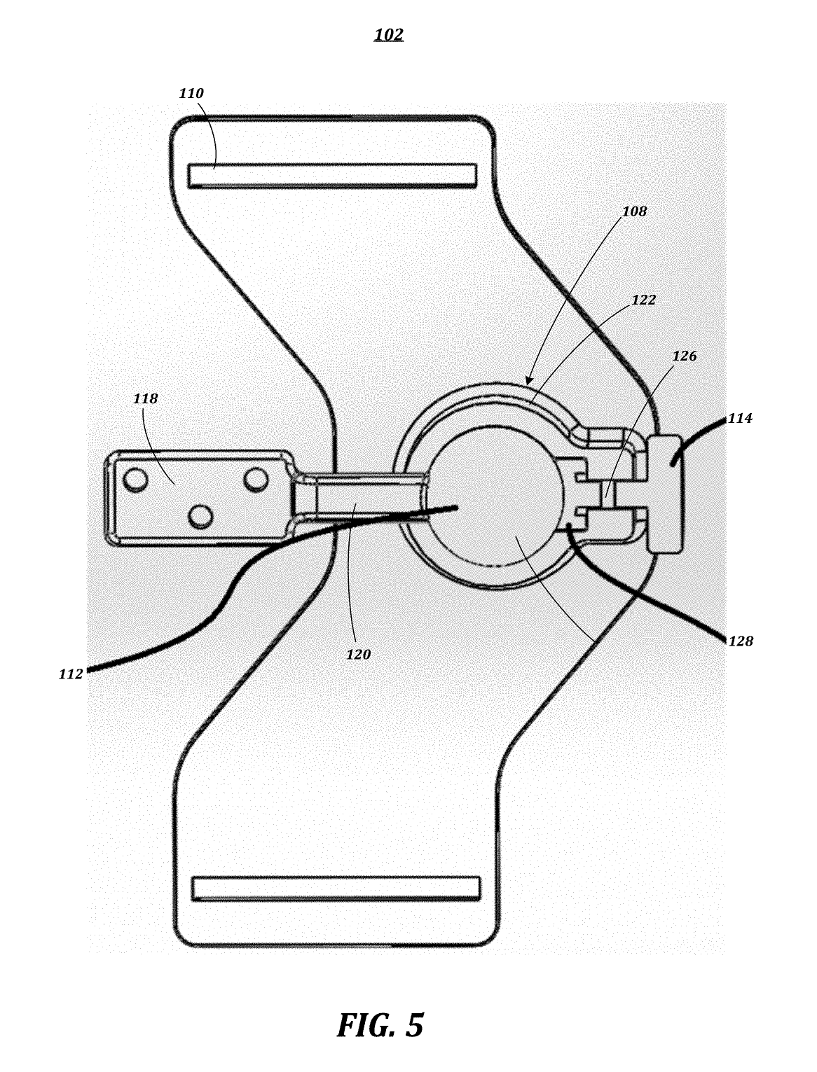

In further aspects, FIGS. 3-5 show various views of an exemplary base plate 102 in accordance with the present invention. The base plate 102 comprises a pivot ball joint 108, including: a pivot ball 112 with a pin 120 and mounting plate 118, a socket for receiving said ball, a cover plate 122 for securing the pivot ball in the socket, an adjustment knob 114. As shown, the cover plate comprises guide slots 124 configured to receive the pin and control the motion of the auxiliary visor panel and allow the auxiliary visor panel to move to a predetermined position. As shown in FIG. 5, the adjustment knob 114 comprises a clamping arm 126 and clamping face 128, and the adjustment knob is configured to control the motion of the auxiliary visor panel by adjusting the adjustment knob towards and away from the pivot ball. The adjustment knob 114 is configured to fix the auxiliary visor panel position or otherwise prevent movement of the auxiliary visor panel by tightening the clamping face 128 against the pivot ball 112. The clamping face 128 has an arcuate shape substantially matching the shape of the pivot ball 112.

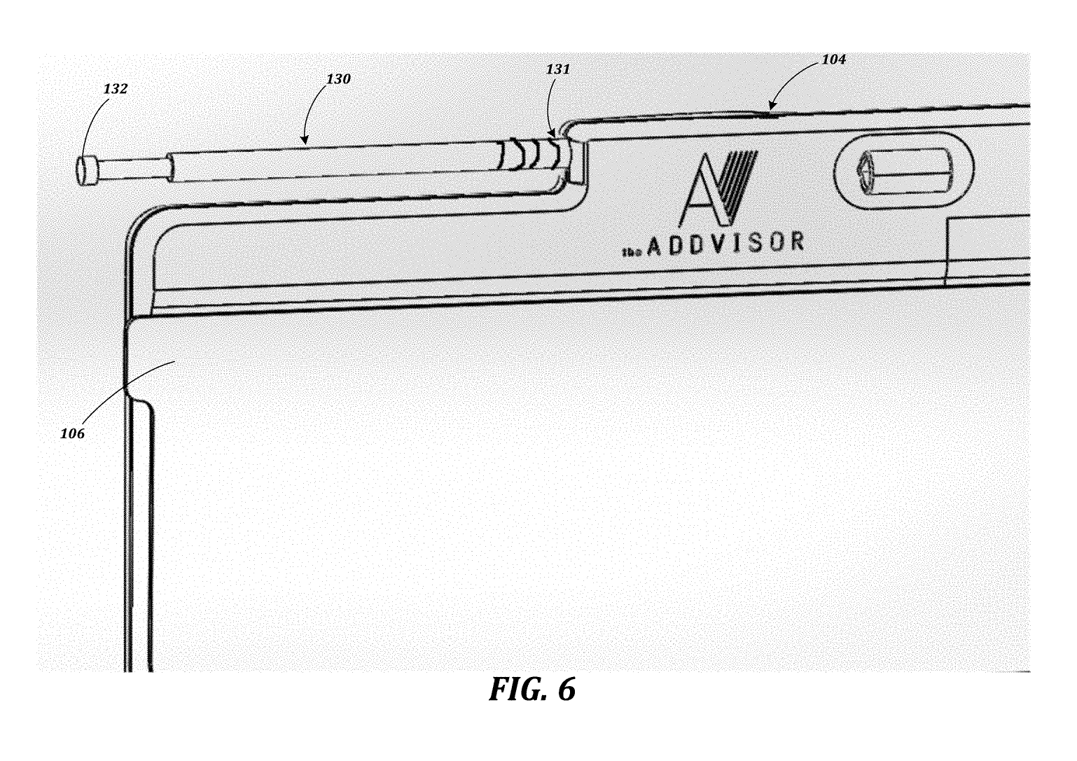

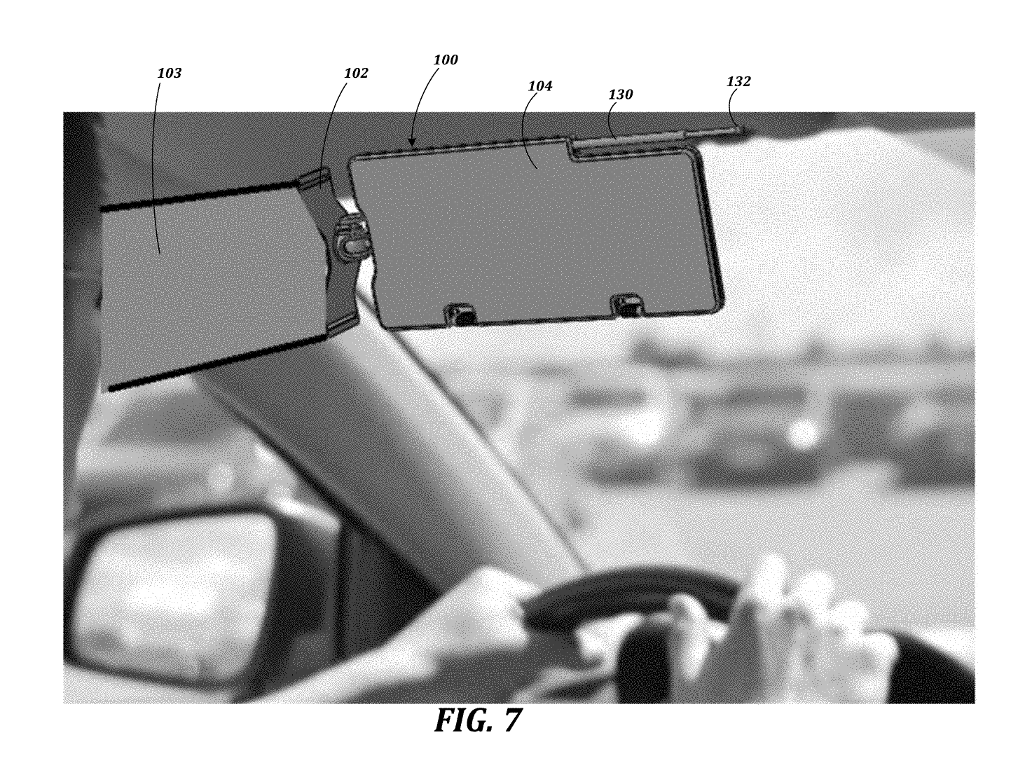

In further aspects, FIG. 6 shows an alternate view of the extendable member 130, where the extension rod is configured to telescope from within the extendable member. Here, the extendable member comprises a flexible portion 131 at one end to allow the extendable member to flex and rotate to reach an OEM visor retention device or clip. As shown in FIG. 7, the visor system 100 is secured to an OEM vehicle visor 103, where at least a portion of the extendable member 130 or extension rod 132 can positioned and extended to be releasably secured to an OEM visor retention device or clip.

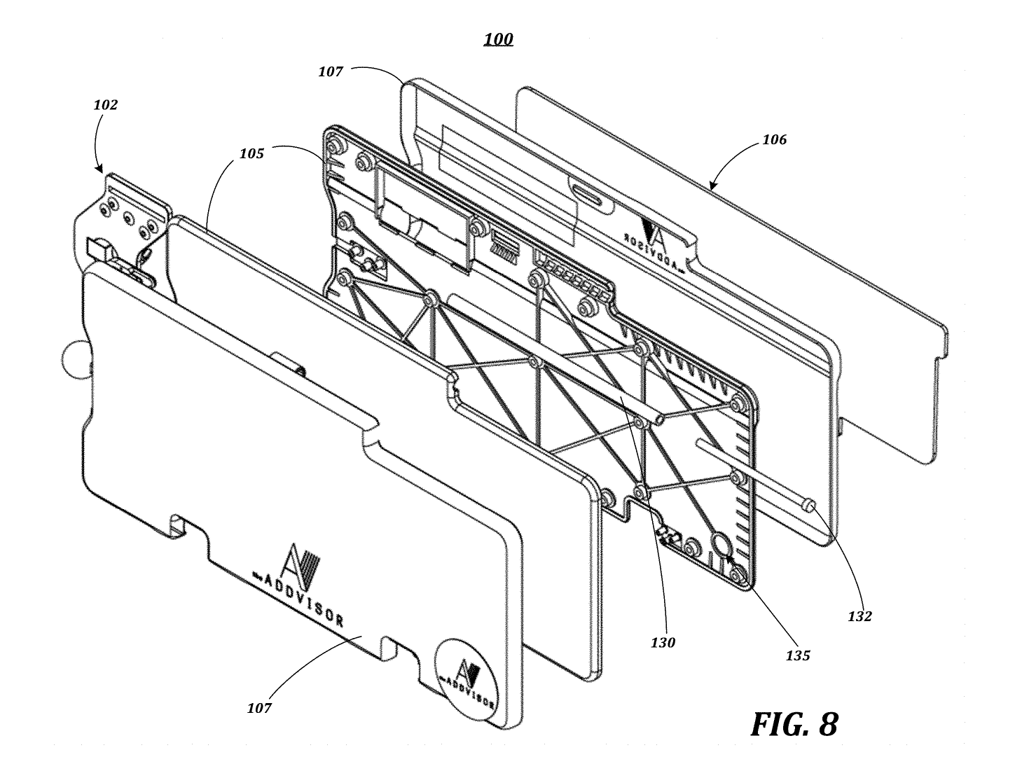

As shown in FIG. 8, the auxiliary panel can comprise an internal housing 105 and an outer casing 107. In further aspects, the base plate 102 can be configured to be secured to a first portion of a vehicle visor; while the auxiliary panel 104 can comprise another securing means configured to be secured to a second portion of a vehicle visor. Here, the auxiliary panel securing can comprise a magnet 134 and corresponding magnetic element 134, the magnet being configured to magnetically couple with the corresponding magnetic element. As shown, the magnet is disposed within the internal housing of the auxiliary panel, while the magnetic element is configured to be disposed on a surface of or within a vehicle visor.

In accordance with the present disclosure, the invention includes at least the following aspects:

Aspect 1: A visor system, the system comprising: a) at least one base plate configured to be releasably secured to a portion of a vehicle; b) at least one auxiliary visor panel rotatably or pivotably connected to the base plate; and c) a glare shield movably connected to the auxiliary visor panel.

Aspect 2: A visor system, the system comprising: a) at least one base bracket configured to be releasably secured to a portion of a vehicle; b) at least one auxiliary visor panel rotatably or pivotably connected to the base bracket; and c) a glare shield movably connected to the auxiliary visor panel.

Aspect 3: A visor system, the system comprising: at least one base plate configured to be releasably secured to a portion of a vehicle visor, the base plate comprising a plurality of securing means configured to be secured to different portions of the vehicle visor; at least one auxiliary visor panel pivotably connected to the base plate using a pivot ball joint; wherein the pivot ball joint comprises a pivot ball with a pin extending therefrom, a socket for receiving said ball, and a retaining means for securing the pivot ball in the socket; and a glare shield movably connected to the auxiliary visor panel.

Aspect 4: A visor system, the system comprising: at least one auxiliary visor panel pivotably connected to a portion of a vehicle roof or visor using a pivot ball joint; wherein the pivot ball joint comprises a pivot ball with a pin extending therefrom, a socket for receiving said ball, and a retaining means for securing the pivot ball in the socket; and a glare shield movably connected to the auxiliary visor panel.

Aspect 5: The system of any preceding aspect, further comprising a plurality of base plates or brackets.

Aspect 6: The system of any preceding aspect, further comprising a plurality of auxiliary visor panels.

Aspect 7: The system of any preceding aspect, wherein the base plate is releasably secured using a securing means.

Aspect 8: The system of any preceding aspect, wherein the base plate is releasably secured to a vehicle visor or roof.

Aspect 9: The system of any preceding aspect, wherein the base plate is releasably secured using a securing means.

Aspect 10: The system of any preceding aspect, wherein the base plate comprises at least one aperture for receiving the securing means.

Aspect 11: The system of any preceding aspect, wherein the base plate comprises a plurality of apertures for receiving the securing means.

Aspect 12: The system of any preceding aspect, wherein the base plate is releasably secured to a vehicle visor or roof.

Aspect 13: The system of any preceding aspect, wherein the base plate comprises a triangular shape, and is configured to be secured to a corner of the vehicle visor.

Aspect 14: The system of any preceding aspect, wherein the base plate comprises a plurality of securing means.

Aspect 15: The system of any preceding aspect, wherein the auxiliary visor panel is pivotably connected using a connecting means.

Aspect 16: The system of any preceding aspect, wherein the auxiliary visor panel further comprises a securing means configured to releasably secure a portion of the auxiliary visor panel to a vehicle visor or roof.

Aspect 17: The system of any preceding aspect, wherein the auxiliary visor panel is pivotably connected using a pivot ball joint, or the like.

Aspect 18: The system of any preceding aspect, wherein the pivot ball joint comprises a pivot ball with a pin extending therefrom, a socket for receiving said ball, and a cover plate for securing the pivot ball in the socket.

Aspect 19: The system of any preceding aspect, wherein the pivot ball joint comprises a pivot ball with a pin extending therefrom, a magnetic socket for receiving said ball, and a retaining means for securing the pivot ball in the socket.

Aspect 20: The system of any preceding aspect, wherein the pivot ball pin comprises a mounting portion configured to connect with the auxiliary panel.

Aspect 21: The system of any preceding aspect, wherein the cover plate comprises at least one guide slot configured to receive the pin and control the motion of the auxiliary visor panel.

Aspect 22: The system of any preceding aspect, wherein the cover plate comprises a plurality of guide slots configured to control the motion of the auxiliary visor panel.

Aspect 23: The system of any preceding aspect, wherein the cover plate is configured to allow the auxiliary visor panel to move to a predetermined position.

Aspect 24: The system of any preceding aspect, wherein the pivot ball joint comprises a retaining means configured to hold the auxiliary visor panel in a predetermined position.

Aspect 25: The system of any preceding aspect, wherein the retaining means is configured to Aspect 26: The system of any preceding aspect, wherein the cover plate is configured to allow the auxiliary visor panel to move to a plurality of predetermined positions.

Aspect 27: The system of any preceding aspect, wherein the cover plate is configured to allow the auxiliary visor panel to move from a first predetermined position to a second predetermined position or a third predetermined position.

Aspect 28: The system of any preceding aspect, wherein the retaining means is in operative communication with the socket and configured to control the motion of the auxiliary visor panel.

Aspect 29: The system of any preceding aspect, wherein the retaining means is configured to control the motion of the ball.

Aspect 30: The system of any preceding aspect, wherein the retaining means is further configured to allow the auxiliary visor panel to move to a predetermined position.

Aspect 31: The system of any preceding aspect, wherein the retaining means is further configured to hold the auxiliary visor panel in a predetermined position.

Aspect 32: The system of any preceding aspect, wherein the retaining means is configured to allow the auxiliary visor panel to move to a plurality of predetermined positions.

Aspect 33: The system of any preceding aspect, wherein the retaining means is configured to allow the auxiliary visor panel to move from a first predetermined position to a second predetermined position or a third predetermined position.

Aspect 34: The system of any preceding aspect, wherein the predetermined position comprises a stowed position against the vehicle visor, a side window position, or an extended position against the windshield.

Aspect 35: The system of any preceding aspect, further comprising first and second auxiliary visor panels.

Aspect 36: The system of any preceding aspect, wherein the first auxiliary visor panel is rotatably connected to at least a portion of the base plate or second auxiliary visor panel, or a combination thereof.

Aspect 37: The system of any preceding aspect, wherein the second auxiliary visor panel is rotatably connected to at least a portion of the base plate or the first auxiliary visor panel, or a combination thereof.

Aspect 38: The system of any preceding aspect, wherein the first auxiliary visor panel is rotatably connected to at least a portion of the base plate, and the second auxiliary visor panel is rotatably connected to a different portion of the first auxiliary visor panel.

Aspect 39: The system of any preceding aspect, wherein the first or second auxiliary visor panels are rotatably connected to an edge of the base plate or second auxiliary visor panel, or a combination thereof.

Aspect 40: The system of any preceding aspect, wherein the base plate is rotatably connected to a first edge of the first auxiliary visor panel, and the second auxiliary visor panel is rotatably connected to a different edge of the first auxiliary visor panel.

Aspect 41: The system of any preceding aspect, wherein the second auxiliary visor panel is nestably connected to the first auxiliary visor panel.

Aspect 42: The system of any preceding aspect, wherein the auxiliary visor panel comprises at least one edge configured to releasably couple with at least one of: at least one other auxiliary visor panel edge, or base plate edge, or combinations thereof.

Aspect 43: The system of any preceding aspect, wherein the first auxiliary visor panel comprises at least one edge configured to releasably couple with at least one of: at least one other auxiliary visor panel edge, or base plate edge, or combinations thereof.

Aspect 44: The system of any preceding aspect, wherein the second auxiliary visor panel comprises at least one edge configured to releasably couple with at least one of: at least one other auxiliary visor panel edge, or base plate edge, or combinations thereof.

Aspect 45: The system of any preceding aspect, wherein the second auxiliary visor panel comprises at least one edge configured to releasably couple with a first auxiliary visor panel edge and a base plate edge.

Aspect 46: The system of any preceding aspect, wherein the second auxiliary visor panel comprises a first edge configured to releasably couple with a first auxiliary visor panel edge and a second edge configured to releasably couple with a base plate edge.

Aspect 47: The system of any preceding aspect, wherein the first auxiliary visor panel comprises at least one edge that define a cavity for receiving at least a portion of the second auxiliary visor panel.

Aspect 48: The system of any preceding aspect, wherein the base plate comprises a plurality of thickness.

Aspect 49: The system of any preceding aspect, wherein the base plate comprises first and second surfaces.

Aspect 50: The system of any preceding aspect, wherein at least one surface of the base plate comprises an elevation portion and a recessed portion.

Aspect 51: The system of any preceding aspect, wherein the recessed portion is configured to nestably receive at least a portion of the first auxiliary visor panel.

Aspect 52: The system of any preceding aspect, wherein the elevated portion of the base plate and the cavity of the first auxiliary visor panel form a substantially planar surface when in a nesting position.

Aspect 53: The system of any preceding aspect, wherein an edge of the elevated portion of the base plate and complimentary edge of the surface the cavity of the first auxiliary visor panel have an ‘S’ or crescent shape.

Aspect 54: The system of any preceding aspect, wherein the auxiliary visor panel is rotatably connected to at least a portion of the base bracket, and the glare shield is rotatably connected to a different portion of the auxiliary visor panel.

Aspect 55: The system of any preceding aspect, wherein the base bracket is rotatably connected to a first edge of the auxiliary visor panel, and the glare shield is pivotably connected to a different edge of the auxiliary visor panel.

Aspect 56: The system of any preceding aspect, wherein the glare shield is nestably connected to the auxiliary visor panel.

Aspect 57: The system of any preceding aspect, wherein the auxiliary visor panel comprises at least one edge configured to releasably couple with at least one of: vehicle visor, base bracket edge, or combinations thereof.

Aspect 58: The system of any preceding aspect, further comprising at least one storage compartment.

Aspect 59: The system of any preceding aspect, wherein the storage compartment comprises a slot or cavity configured to releasably secure pens, cards, or a combination thereof.

Aspect 60: The system of any preceding aspect, wherein the retaining means comprises a friction fitting, snap ring, O-ring, pressure fitting, magnetic fitting, clip, clasp, and the like.

Aspect 61: The system of any preceding aspect, wherein the snap ring or O-ring can be retained within a groove to accommodate the snap ring or O-ring.

Aspect 62: The system of any preceding aspect, wherein auxiliary visor panel comprises a cavity or void for receiving the glare shield.

Aspect 63: The system of any preceding aspect, wherein the glare shield is slidably connected to the auxiliary visor panel.

Aspect 64: The system of any preceding aspect, wherein the glare shield is pivotably connected to the auxiliary visor panel.

Aspect 65: The system of any preceding aspect, wherein the glare shield is connected using a connecting means.

Aspect 66: The system of any preceding aspect, wherein the glare shield is configured to extend from the auxiliary visor panel to reduce glare or bright light when the auxiliary visor panel is a raised position.

Aspect 67: The system of any preceding aspect, wherein the securing means comprises a clip, clamp, latch, bracket, snap, fitting, clasp, Velcro, strap, tie wraps, hook and latch fastener, loop and tie fastener, cable, elastic, band, button and buttonholes, or combinations thereof.

Aspect 68: The system of any preceding aspect, wherein the connecting means comprises a hinge or similar connecting mechanism.

Aspect 69: The system of any preceding aspect, wherein the system can comprise a button or other release mechanism configured to release the auxiliary panel and/or glare shield from a secured position.

Aspect 70: The system of any preceding aspect, wherein the base plate can comprise a plurality of securing or connecting means, such as, and without limitation, Velcro at one portion and a clamping mechanism on another portion of the base plate.

Aspect 71: The system of any preceding aspect, wherein the base plate can comprise a securing means for releasably securing the auxiliary visor panel to the base plate.

Aspect 72: The system of any preceding aspect, wherein the base plate can have a rectangular, oval, round, or cylindrical shape.

Aspect 73: The system of any preceding aspect, wherein the glare shield is comprised of an UV-reducing and/or glare-reducing material, or a combination thereof.

Aspect 74: The system of any preceding aspect, wherein the glare shield is comprised of an opaque, micro-louver, transparent, tinted, translucent, polarized, phototropic, electrochromic, fabric, cloth, plastic, woven or non-woven, natural or synthetic material, or combinations thereof.

Aspect 75: The system of any preceding aspect, wherein the glare shield comprises a tinted acrylic panel.

Aspect 76: The system of any preceding aspect, wherein the auxiliary visor panel is pivotally mounted to a vehicle visor such that it can pivot downwardly and away from the primary visor without encroaching in the user's space when the vehicle visor is in the side window position.

Aspect 77: The system of any preceding aspect, wherein the base plate comprises a triangular shape, and is configured to be secured to a corner of the vehicle visor.

Aspect 78: The system of any preceding aspect, wherein at least one securing means is configured to be secured to first portion of the vehicle visor, and at least one other securing means is configured to be secured to a second portion of the vehicle visor.

Aspect 79: The system of any preceding aspect, wherein the at least other securing means comprises a magnet and corresponding magnetic element.

Aspect 80: The system of any preceding aspect, wherein the magnet is disposed within the auxiliary panel.

Aspect 81: The system of any preceding aspect, wherein the auxiliary visor panel further comprises a securing means configured to releasably secure a portion of the auxiliary visor panel to third portion of the vehicle visor.

Aspect 82: The system of any preceding aspect, wherein system components are releasably coupled using a coupling means.

Aspect 83: The system of any preceding aspect, wherein the coupling means comprise friction fitting, snap ring, O-ring, pressure fitting, clip, clasp, and the like.

Aspect 84: The system of any preceding aspect, wherein the coupling means is configured to hold a system component in place until a user moves the system component to a different position.

Aspect 85: The system of any preceding aspect, wherein the base plate comprises a socket for receiving the pivot ball.

Aspect 86: The system of any preceding aspect, wherein the socket for receiving the pivot ball is attached to a portion of the vehicle.

Aspect 87: The system of any preceding aspect, wherein the socket for receiving the pivot ball is attached to a portion of the vehicle roof or vehicle visor.

Aspect 88: The system of any preceding aspect, wherein the base plate or base bracket is an OEM vehicle part, and the at least one auxiliary visor panel is configured to be attached by inserting the pivot ball in the socket.

Aspect 89: The system of any preceding aspect, wherein the base plate is an OEM vehicle visor comprising a socket for receiving the pivot ball, and the at least one auxiliary visor panel is configured to be attached by inserting the pivot ball in the socket.

Aspect 90: The system of any preceding aspect, wherein the retaining means comprises an adjustment knob having at least one of a clamping arm and clamping face.

Aspect 91: The system of any preceding aspect, wherein the adjustment knob is configured to control the motion of the auxiliary visor panel by adjusting the adjustment knob towards and away from the pivot ball.

Aspect 92: The system of any preceding aspect, wherein the adjustment knob is configured to prevent motion of the auxiliary visor panel by screwing the adjustment knob towards the pivot ball.

Aspect 93: The system of any preceding aspect, wherein the adjustment knob is configured to allow motion of the auxiliary visor panel by screwing the adjustment knob away from the pivot ball.

Aspect 94: The system of any preceding aspect, wherein the adjustment knob is configured to control the motion of the auxiliary visor panel by tightening the clamping face of the adjustment knob against the pivot ball.

Aspect 95: The system of any preceding aspect, wherein the adjustment knob is configured to prevent movement of the auxiliary visor panel by tightening the clamping face of the adjustment knob against the pivot ball.

Aspect 96: The system of any preceding aspect, wherein the adjustment knob is configured to fix the auxiliary visor panel position by tightening the clamping face of the adjustment knob against the pivot ball.

Aspect 97: The system of any preceding aspect, wherein the clamping face of the adjustment knob has an arcuate shape substantially matching the shape of the pivot ball.

Aspect 98: The system of any preceding aspect, wherein the base plate comprises at least two apertures for receiving a securing means, the apertures being contained within a base plate edge; and the securing means having first and second opposed ends, the first end of the securing means being detachably connected to the base plate by extending through a first aperture from a first side of the base plate to a second side of the base plate, and by extending through a second aperture from the second side of the base plate to the first side of the plate.

Aspect 99: The system of any preceding aspect, wherein a first side of the base plate is configured to be secured against a surface of an OEM visor.

Aspect 100: The system of any preceding aspect, wherein a first side of the base plate comprises a gripping portion.

Aspect 101: The system of any preceding aspect, wherein a second side of the base plate comprises a pivot ball joint.

Aspect 102: The system of any preceding aspect, further comprising an extendable member, the extendable member having first and second opposed ends.

Aspect 103: The system of any preceding aspect, wherein the extendable member is connected to the auxiliary panel at a first end.

Aspect 104: The system of any preceding aspect, wherein the extendable member comprises an extension rod.

Aspect 105: The system of any preceding aspect, wherein the extendable member is connected to the auxiliary panel at a first end and comprises an extension rod at a second end.

Aspect 106: The system of any preceding aspect, wherein the extendable member comprises a flexible portion at a first end and a rigid portion at a second end.

Aspect 107: The system of any preceding aspect, wherein the extension rod is configured to telescope from within the extendable member.

Aspect 108: The system of any preceding aspect, wherein at least a portion of the extendable member is configured to be releasably secured to an OEM visor retention device or clip.

Aspect 109: The system of any preceding aspect, wherein the auxiliary panel comprises at least one of: at least one internal housing and at least one outer casing.

Aspect 110: The system of any preceding aspect, wherein the auxiliary panel comprises at least one internal housing and at least one outer casing.

Aspect 111: The system of any preceding aspect, wherein the internal housing comprises a first housing panel and a second housing panel.

Aspect 112: The system of any preceding aspect, wherein the base bracket comprises at least one securing means configured to be secured to first portion of a vehicle visor; and wherein the auxiliary panel comprises at least one securing means configured to be secured to a second portion of a vehicle visor.

Aspect 113: The system of any preceding aspect, wherein the at least one securing means of the auxiliary panel comprises a magnet and corresponding magnetic element, the magnet being configured to magnetically couple with the corresponding magnetic element.

Aspect 114: The system of any preceding aspect, wherein at least a portion of the auxiliary securing mean is disposed within the auxiliary panel.

Aspect 115: The system of any preceding aspect, wherein the magnet is disposed within the auxiliary panel.

Aspect 116: The system of any preceding aspect, wherein the magnet is disposed within the internal housing of the auxiliary panel.

Aspect 117: The system of any preceding aspect, wherein the magnet is disposed within the internal housing of the auxiliary panel and the magnetic element is disposed on a surface of or with a vehicle visor.

Aspect 118: The system of any preceding aspect, wherein the magnetic element is a metal plate.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A visor system, the system comprising:
a) at least one base plate configured to be releasably secured to a portion of a vehicle;
b) at least one auxiliary visor panel rotatably or pivotably connected to the base plate; and
c) a glare shield movably connected to the auxiliary visor panel.

2.-6. (canceled)

7. The system of claim 1, wherein the base plate is releasably secured using a securing means.

8.-16. (canceled)

17. The system of claim 7, wherein the auxiliary visor panel is pivotably connected using a pivot ball joint, the pivot ball joint comprising a pivot ball with a pin extending therefrom, a socket for receiving said ball, and a cover plate for securing the pivot ball in the socket.

18.-21. (canceled)

22. The system of claim 17, wherein the cover plate comprises a plurality of guide slots configured to control the motion of the auxiliary visor panel.

23. (canceled)

24. The system of claim 22, wherein the pivot ball joint comprises a retaining means configured to hold the auxiliary visor panel in a predetermined position.

25.-27. (canceled)

28. The system of claim 24, wherein the retaining means is in operative communication with the socket and configured to control the motion of the auxiliary visor panel.

29.-77. (canceled)

78. The system of claim 22, further comprising a plurality of securing means; wherein at least one securing means is configured to be secured to a first portion of a vehicle visor, and at least one other securing means is configured to be secured to a second portion of the vehicle visor.

79. The system of claim 78, wherein the at least one other securing means comprises a magnet and corresponding magnetic element.

80.-89. (canceled)

90. The system of claim 79, wherein the retaining means comprises an adjustment knob having at least one of a clamping arm and clamping face.

91.-93. (canceled)

94. The system of claim 90, wherein the adjustment knob is configured to control the motion of the auxiliary visor panel by tightening the clamping face of the adjustment knob against the pivot ball.

95.-98. (canceled)

99. The system of claim 94, wherein a first side of the base plate is configured to be secured against a surface of an OEM visor.

100. The system of claim 94, wherein a first side of the base plate comprises a gripping portion, and a second side of the base plate comprises the pivot ball joint.

101. (canceled)

102. The system of claim 100, further comprising an extendable member, the extendable member having first and second opposed ends and configured to be releasably secured to an OEM visor retention device.

103.-104. (canceled)

105. The system of claim 102, wherein the extendable member is connected to the auxiliary panel at the first end and comprises an extension rod at the second end.

106. The system of claim 102, wherein the extendable member comprises a flexible portion at the first end and a rigid portion at the second end.

107.-108. (canceled)

109. The system of claim 102, wherein the auxiliary panel comprises at least one of: at least one internal housing and at least one outer casing.

110.-111. (canceled)

112. The system of claim 109, wherein the base plate comprises at least one securing means configured to be secured to first portion of a vehicle visor; and wherein the auxiliary panel comprises at least one securing means configured to be secured to a second portion of a vehicle visor.

113. The system of claim 112, wherein the at least one securing means of the auxiliary panel comprises a magnet and corresponding magnetic element, the magnet being configured to magnetically couple with the corresponding magnetic element.

114. The system of claim 113, wherein at least a portion of the at least one securing means of the auxiliary panel is disposed within the auxiliary panel.

115.-118. (canceled)

119. A visor system, the system comprising:
at least one base plate configured to be releasably secured to a vehicle visor, the base plate comprising:
a gripping portion on a first side and a pivot ball joint on a second side of the base plate, wherein the pivot ball joint comprises: a pivot ball with a pin extending therefrom, a socket for receiving said ball, a cover plate for securing the pivot ball in the socket, the cover plate including a plurality of guide slots configured to control the motion of an auxiliary visor panel, and a retaining means, the retaining means being in operative communication with the socket and configured to control the motion of an auxiliary visor panel;
at least one auxiliary visor rotatably or pivotably connected to the base plate by the pivot ball joint, the at least one auxiliary visor comprising:
at least one internal housing, at least one outer casing, and an extendable member, the extendable member having first and second opposed ends and configured to be releasably secured to an OEM visor retention device; and
a glare shield movably connected to the auxiliary visor panel;
wherein the base plate comprises at least one securing means configured to be secured to first portion of the vehicle visor; and wherein the auxiliary panel comprises at least one securing means configured to be secured to a second portion of the vehicle visor;
wherein the at least one securing means of the auxiliary panel comprises a magnet and corresponding magnetic element, the magnet being configured to magnetically couple with the corresponding magnetic element; at least a portion of the auxiliary at least one securing means mean of the auxiliary panel being disposed within the auxiliary panel; and
wherein the extendable member is connected to the auxiliary panel at the first end and comprises an extension rod at the second end; and wherein the extendable member comprises a flexible portion at the first end and a rigid portion at the second end.
